(19) United States
(12) Patent Application Publication
(10) Pub. No.: US 2017/0295513 A1
(43) Pub. Date: Oct. 12, 2017

(54) Managing Access To Receive Chains Of A Multi-Subscription Multi-Standby Communication Device

(71) Applicant: QUALCOMM Incorporated, San Diego, CA (US)

(72) Inventors: Kuo-Chun Lee, San Diego, CA (US); Sivaramakrishna Veerepalli, San Diego, CA (US); Chih-Ping Hsu, San Diego, CA (US); Jack Shyh-Hurng Shauh, San Diego, CA (US); Shailesh Maheshwari, San Diego, CA (US); Mohan Krishna Gowda, Sunnyvale, CA (US); Alexey Semjonovs, San Diego, CA (US); Omar Sabbarini, San Diego, CA (US); Daniel Amerga, San Diego, CA (US); Shishir Ramesha, San Diego, CA (US); Pavan Chaithanya Kiavaram, San Diego, CA (US); Ramchandran Srinivasan, San Diego, CA (US)

(21) Appl. No.: 15/630,062

(22) Filed: Jun. 22, 2017

Related U.S. Application Data
(63) Continuation-in-part of application No. 14/873,652, filed on Oct. 2, 2015.
(60) Provisional application No. 62/218,308, filed on Sep. 14, 2015.

(51) Int. Cl. H04W 28/02; H04W 40/12

(52) U.S. Cl. CPC H04W 28/0205; H04W 40/12; H04W 88/06

(57) ABSTRACT

Embodiments include systems and methods for managing access to receive chains of a multi-subscription multi-standby (MSMS) communication device. A device processor may determine a receive mode of the MSMS communication device. In response to determining that the receive mode is a diversity sharing mode, the device processor may determine a first subscription schedule and a second subscription schedule. The device processor may that there is an upcoming overlap between the first subscription schedule and the second subscription schedule, and in response the device processor may prevent the second subscription from using the second receive chain.

### RELATED APPLICATIONS

This application is a continuation-in-part of, and claims the benefit of priority to, U.S. Non-Provisional application Ser. No. 14/873,652 entitled “Managing Access To Receive Chains Of A Multi-Subscription Multi-Standby Communication Device” filed on Oct. 2, 2015, which claims priority to U.S. Provisional Application No. 62/218,308 entitled “Managing Access To Receive Chains Of A Multi-Subscription Multi-Standby Communication Device” filed Sep. 14, 2015, the entire contents of both of which are hereby incorporated by reference.

### BACKGROUND

A multi-subscription multi-standby (MSMS) communication device may include two or more subscriber identity module (SIM) cards. Each SIM may be associated with a different service provider subscription, enabling the MSMS communication device to communicate with two or more communication networks. MSMS communication devices may also be configured to utilize a variety of radio access technology protocols (RAT), for example, examples of which include Long Term Evolution (LTE), Global System for Mobility (GSM), and Wideband Code Division Multiple Access (WCDMA).

MSMS communication devices may be provided in a range of configurations. For example, in a dual-subscription dual-standby (DSDS) configuration, two SIMs may share a set of receive (Rx) circuitry (referred to as an “Rx chain” or a “receive chain”). As another example, an MSMS communication device may be configured as a dual receive (DR) device (DR-MSMS), in which the MSMS communication device includes a radio frequency (RF) resource (e.g., a transceiver) that includes one set of transmit (Tx) circuitry (referred to as a “Tx chain” or a “transmit chain”) and two (or more) RF chains. While a DR-MSMS device may typically only transmit using a single RAT at a time because the DR-MSMS communication device includes one Tx chain, the DR-MSMS communication device may simultaneously receive signals using two (or more) different subscriptions (each of which may utilize a different RAT).

A DR-MSMS communication device may also employ a “tune-away” procedure by tuning one Rx chain away to a second network in a second cell for a short time, and then tuning the Rx chain back to the first network. This tune-away procedure may allow the MSMS communication device to monitor for pages or other indications of incoming messages or data received on the second network. However, tuning away to another network may decrease the throughput of communications between the MSMS communication device and the first network, and may degrade the quality of an active communication session over the first network. For example, during a tune-away event, communication activities using the first subscription may be reduced or interrupted, and data may be partially or entirely lost, which may degrade overall reception performance over the first subscription. Tune-away events may be especially disruptive to the first subscription's reception service and performance in situations in which the first subscription is prevented from receiving time-sensitive data, such as when the first subscription receives streaming multimedia (e.g., video and audio data segments) via multi-media broadcast multicast services, such as the Evolved Multimedia Broadcast Multicast Service (eMBMS).

### SUMMARY

Various embodiments include methods for managing access to a first receive chain and a second receive chain of a multi-subscription multi-standby (MSMS) communication device by a plurality of subscriptions of the MSMS communication device during receipt of a broadcast data stream. Various methods may include determining a receive mode of the MSMS communication device, and taking actions to manage access to the first and second receive chains depending upon the receive mode.

In response to determining that the receive mode is a diversity sharing mode, some embodiments may include determining a schedule of communication activity of a first subscription (first subscription schedule) and a schedule of communication activity of a second subscription (second subscription schedule), determining whether there is an upcoming overlap between the first subscription schedule and the second subscription schedule, and preventing the second subscription from using the second receive chain in response to determining that there is an upcoming overlap between the first subscription schedule and the second subscription schedule. Some embodiments may further include receiving the first subscription using the first receive chain and a second receive path of the second receive chain.

In some embodiments, preventing the second subscription from using a first receive path of the second receive chain in response to determining that there is an upcoming overlap between the first subscription schedule and the second subscription schedule may include monitoring a data loss from the broadcast data stream, determining whether the monitored data loss and an expected data loss exceed a threshold, preventing the second subscription from using a first receive path of the second receive chain in response to determining that the monitored data loss and the expected data loss exceeds the threshold. Such embodiments may further include enabling the second subscription to use the first receive path of the second receive chain in response to determining that the monitored data loss and the expected data loss does not exceed the threshold.

In some embodiments, preventing the second subscription from using a first receive path of the second receive chain in response to determining that the monitored data loss and the expected data loss exceeds the threshold may include determining whether the monitored data loss is less than or equal to the threshold, and preventing the second subscription from using a first receive path of the second receive chain in response to determining that the monitored data loss and the expected data loss exceeds the threshold and that the monitored data loss is less than or equal to the threshold. Such embodiments may further include enabling the second subscription to use the first receive path of the second receive chain in response to determining that the monitored data loss is not less than or equal to the threshold.

Further embodiments include a multi-subscription, multi-standby communication device having a memory, a radio frequency (RF) resource having a transmit chain in, a first receive chain, and a second receive chain, and a processor configured with processor-executable instructions to perform operations of the methods described above. Further embodiments include a multi-subscription, multi-standby communication device having a memory, a radio frequency (RF) resource having means for performing functions of the methods described above. Further embodiments include a non-transitory processor-readable medium having stored thereon processor-executable instructions configured to cause a processor of a multi-subscription, multi-standby communication device to perform operations of the methods described above.

### BRIEF DESCRIPTION OF THE DRAWINGS

The accompanying drawings, which are incorporated herein and constitute part of this specification, illustrate exemplary embodiments. Together with the general description given above and the detailed description given below, the drawings serve to explain features of the various embodiments, and not to limit the various embodiments.

FIG. 1 is a component block diagram of a communication system suitable for use with various embodiments.

FIG. 2 is a component block diagram of a multi-subscription multi-standby communication device according to various embodiments.

FIG. 3 is a component block diagram of a multi-subscription multi-standby communication device according to various embodiments.

FIG. 4 is a process flow diagram illustrating a method for managing access to a first receive chain and a second receive chain of a multi-subscription multi-standby communication device according to various embodiments.

FIG. 5 is a process flow diagram illustrating a method for managing access to a first receive chain and a second receive chain of a multi-subscription multi-standby communication device according to various embodiments.

FIG. 6 is a process flow diagram illustrating a method for managing access to a first receive chain and a second receive chain of a multi-subscription multi-standby communication device according to various embodiments.

FIG. 7 is a component block diagram of a multi-subscription multi-standby communication device suitable for use with various embodiments.

FIG. 8 is a process flow diagram illustrating a method for managing access to a first receive chain and a second receive chain of a multi-subscription multi-standby communication device according to various embodiments.

FIG. 9 is a process flow diagram illustrating a method for managing access to a first receive chain and a second receive chain of a multi-subscription multi-standby communication device according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods implemented on an MSMS communication device that enable management of access to Rx chains of the MSMS communication device by some or all of a plurality of subscriptions of the MSMS communication device during reception of a broadcast data stream.

The terms “multi-subscription multi-standby communication device” and “MSMS communication device” refer to any one or all of cellular telephones, smartphones, personal or mobile multi-media players, personal data assistants, laptop computers, tablet computers, smartbooks, palmtop computers, wireless electronic mail receivers, multimedia Internet enabled cellular telephones, wireless gaming controllers, and similar electronic devices and portable computing platforms which include a programmable processor, a memory, and one or more shared RF resources, and which are configured to support communications using two or more subscriptions. Various embodiments may be particularly useful in any communication devices that can support multiple wireless wide area network subscriptions and communication sessions with two or more communication networks. The terms “dual receive multi-subscription multi-standby communication device” and “DR-MSMS communication device” refer to a configuration of an MSMS communication device that includes two or more Rx chains, which enables the MSMS communication device to simultaneously receive signals using two or more different subscriptions (each of which may utilize a different RAT).

The terms “component,” “module,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

References to “first network,” “first subscription,” “second network” and “second subscription” are arbitrary and are used to refer to two or more subscriptions/networks generally because at any given time either subscription/network may be in an active mode (on an active voice or data call) or a standby mode. For example, at a first time, a first subscription with a first network may be on an active data call (and thus a “first” subscription) while a second subscription with a second network is in the standby mode (and thus a “second” subscription), and at a second time, the second subscription may enter an active data call (becoming the “first” subscription) and the first subscription may enter the standby mode (becoming the “second” subscription). Also, references to “first” and “second” subscriptions and networks is not intended to imply that the embodiments are limited to two subscriptions sharing one radio frequency (RF) resource, because three or more subscriptions may share one RF resource provided that only one subscription can use the RF resource at a time. Third and fourth subscriptions would behave similar to a second subscription. Therefore, in the interest of brevity, operations of subscriptions in the standby mode that share the RF resource during tune-away periods are described generally with reference to the “second” subscription.

A DR-MSMS communication device may operate in various receive modes. In full concurrency (FC) mode, the DR-MSMS communication device may receive signals using two or more subscriptions using separate Rx chains simultaneously, eliminating the need to perform a tune-away procedure to the second subscription and any related impact on throughput to a signal received by the MSMS communication device using either subscription that may be caused by the tune-away procedure. In a diversity sharing mode (referred to as “DTA”), the first subscription may use a first Rx chain while a second subscription is not in use to achieve receive diversity, and the first subscription may lose access to the diversity path of first Rx chain when the second subscription performs idle network monitoring operations (e.g., page monitoring, neighboring cell measurements, etc.). In a full tune-away mode (also referred to as a hybrid fallback mode), the first subscription may lose access to the first Rx chain during a tune-away to the second subscription.

In various embodiments, an MSMS device may select one of the receive modes based on a band combination of dual Rx chains and signal level (e.g., a signal strength and/or signal quality) of a paging channel (PCH) of the second subscription. Band combination of dual Rx chains may determine FC mode versus DTA mode. When the PCH signal level is relatively high, the DR-MSMS devices may use FC mode (or DTA mode depending on band combination). As the PCH signal degrades, the DR-MSMS device may change to hybrid fallback mode.

In some embodiments, when the MSMS communication device is receiving a broadcast data stream, such as multimedia data over a broadcast from a first network (e.g., Enhanced Multimedia Broadcast Multicast Services eMBMS)), tuning away from a first subscription to a second subscription may be disruptive to the first subscription service. For example, in situations in which the first subscription is prevented from receiving time-sensitive data by a tune-away, tuning away one of the Rx circuits from the data stream (e.g., in diversity sharing or hybrid fallback mode) to receive a signal from a second network may cause the MSMS communication device to miss or lose data from the data stream.

Various embodiments enable a processor of an MSMS communication device to manage access to Rx chains of the MSMS communication device by one or more of a plurality of subscriptions of the MSMS communication device during reception of a broadcast data stream. In various embodiments, a processor of the MSMS communication device (i.e., a device processor) may determine the current receive mode in which the device is operating (also referred to as an Rx chain operating mode). For example, the device processor may determine whether dual Rx chains are operating in full concurrency mode, diversity sharing mode, or hybrid fallback mode. The device processor may then control access to Rx chains of the MSMS communication device based upon the current receive mode.

In response to determining that the MSMS communication device is operating in full concurrency mode, the device processor may enable two subscriptions to receive concurrently. In some embodiments, the device processor may enable a first subscription to receive a signal using a first Rx chain, and the device processor may enable a second subscription to receive a signal using a second Rx chain.

In response to determining that the MSMS communication device is operating in diversity sharing mode, the device processor may monitor an amount of data loss from the broadcast data stream that is being experienced. In some embodiments, the device processor may monitor the amount of data loss on the basis of a segment or another discrete portion of the broadcast data stream. When the amount of data being lost in transmission is high enough (referred to as a data loss threshold), the MSMS communication device may be unable to recover additional data lost due to a tune-away. Therefore, when the amount of data loss meets a data loss threshold, the device processor may determine whether there is an upcoming overlap in time (a collision) between reception of the broadcast data stream using the first subscription and a scheduled reception of a signal using the second subscription. In response to determining that there is an upcoming overlap between reception activities of the first subscription and the second subscription, the device processor may prevent the second subscription from using the second Rx chain during the overlap, and retain first Rx chain with two receive paths for receiving the broadcast data stream using the first subscription.

In response to determining that the MSMS communication device is operating in hybrid fallback mode, the device processor may monitor an amount of data loss from the broadcast data stream (for example, on a per-segment basis). When the amount of data loss meets a data loss threshold, the device processor may determine whether there is an upcoming overlap in time between reception of the broadcast data stream using the first subscription and a scheduled reception of a signal using the second subscription. In some embodiments, when the MSMS communication device is operating in hybrid fallback mode, the scheduled reception of the signal using the second subscription may include a tune-away event. In response to determining that there is an upcoming overlap, the device processor may prevent the second subscription from using the second Rx chain during the overlap in order to block or prevent the tune-away event.

In some embodiments, in response to determining that the MSMS communication device is operating in diversity sharing mode, the device processor may monitor an amount of data loss from the broadcast data stream (for example, on a per-segment basis). When the amount of data loss meets a data loss threshold, the device processor may determine whether there is an upcoming overlap in time between reception of the broadcast data stream using the first subscription and a scheduled reception of a signal using the second subscription. In response to determining that there is an upcoming overlap, the device processor may enable the second subscription to use the second Rx chain with diversity receive path during the overlap period while receiving the broadcast data stream using the first Rx chain with primary receive path, and using error correction data to recover lost or corrupted data from the broadcast data stream.

In some embodiments, in response to determining that the MSMS communication device is operating in hybrid fallback mode, the device processor may determine whether there is an upcoming overlap in time between reception of the broadcast data stream using the first subscription and a scheduled reception of a signal using the second subscription. In some embodiments, when the MSMS communication device operates in hybrid fallback mode, the scheduled reception of the signal using the second subscription may include a tune-away event. In response to determining that there is an upcoming overlap of broadcast data stream reception by the first subscription and scheduled reception by the second subscription, the device processor may prevent or block reception of the broadcast data stream using the first subscription and enable the second subscription to perform the scheduled reception of the second subscription's signal. For example, the device processor may block reception of eMBMS broadcast data by the first subscription and enable the second subscription to perform a tune-away.

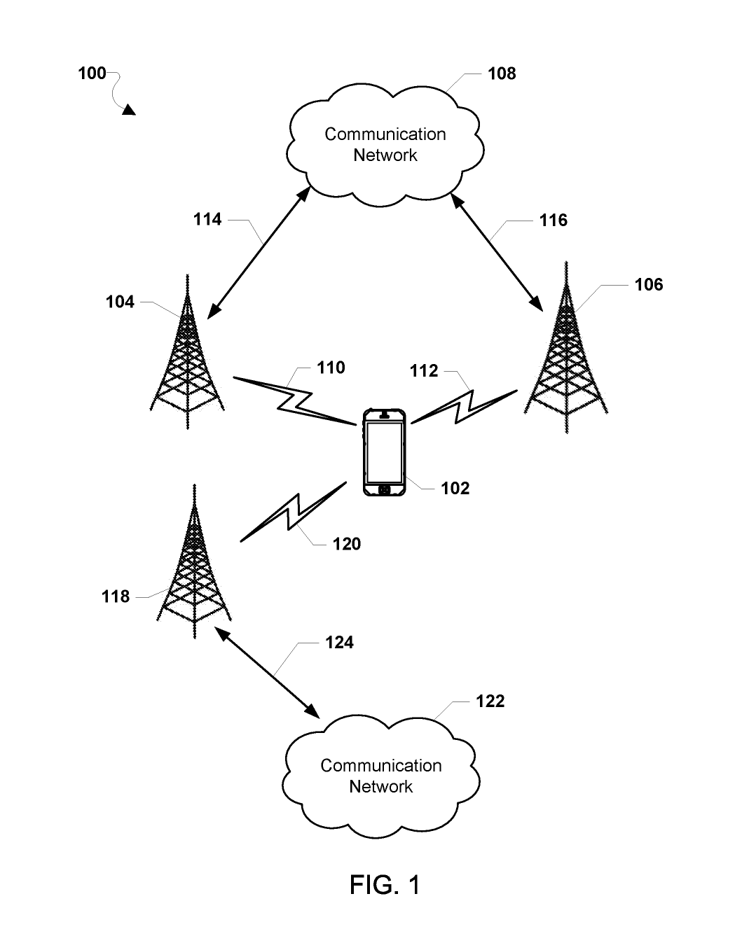

Various embodiments may be implemented in multi-subscription multi-standby communication devices that may operate within a variety of communication systems particularly systems that include two or more communication networks. FIG. 1 illustrates a communication system 100 suitable for use with various embodiments.

An MSMS communication device 102 may communicate with a communication network 108, which may include a plurality of base stations, such as base stations 104, 106. The MSMS communication device 102 may also communicate with a communication network 122, which may include a base station 118. The base station 104 may communicate with the communication network 108 over a wired or wireless communication link 114, which may include fiber optic backhaul links, microwave backhaul links and other similar communication links. The base station 106 may communicate with the communication network 108 over a wired or wireless communication link 116 similar to the communication link 114. The base station 118 may communicate with the communication network 122 over a wired or wireless communication link 124 similar to the communication link 114. In some embodiments, each communication network 108, 122 may include a mobile telephony communication network. The MSMS communication device 102 may communicate with the base station 104 over a wireless communication link 110, with the base station 106 over a wireless communication link 112, and with the base station 118 over a wireless communication link 120.

Each of the communication networks 108, 122 may support communications using one or more RATs, and each of the wireless communication links 110, 112, and 120 may include cellular connections that may be made through two-way wireless communication links using one or more RATs. Examples of RATs may include LTE, GSM, Worldwide Interoperability for Microwave Access (WiMAX), Code Division Multiple Access (CDMA), WCDMA, Time Division Multiple Access (TDMA), Single-Carrier Radio Transmission Technology (1×RTT), Evolution-Data Optimized (EV-DO), and other RATs. While the communication links 110, 112, and 120 are illustrated as single links, each of the communication links may include a plurality of frequencies or frequency bands, each of which may include a plurality of logical channels. Additionally, each of the communication links 110, 112, and 120 may utilize more than one RAT.

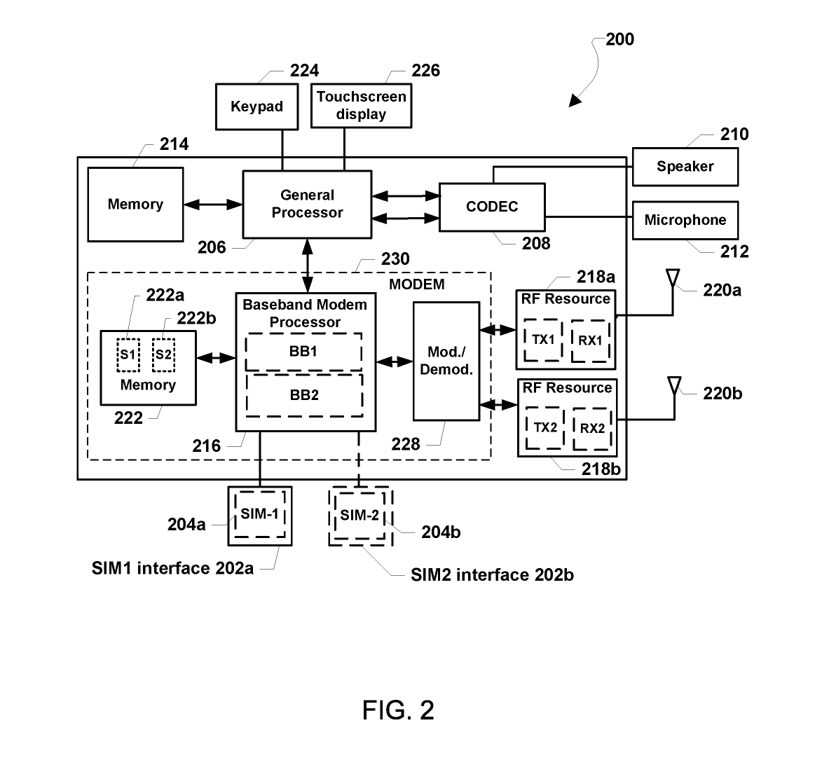

FIG. 2 is a component block diagram of an MSMS communication device 200 suitable for implementing various embodiments. With reference to FIGS. 1 and 2, in various embodiments, the MSMS communication device 200 may be similar to MSMS communication device 102. The MSMS communication device 200 may include a first SIM interface 202a, which may receive a first identity module SIM-1 204a that is associated with a first subscription. The MSMS communication device 200 may optionally also include a second SIM interface 202b, which may receive a second identity module SIM-2 204b that is associated with a second subscription.

A SIM in various embodiments may be a Universal Integrated Circuit Card (UICC) that is configured with SIM and/or USIM (Universal Subscriber Identity Module) applications, enabling access to, for example, GSM and/or Universal Mobile Telecommunications System (UMTS) networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM and I/O circuits. A SIM used in various embodiments may contain user account information, an international mobile subscriber identity (IMSI), a set of SIM application toolkit (SAT) commands and storage space for phone book contacts. A SIM card may further store a Home-Public-Land-Mobile-Network (HPLMN) code to indicate the SIM card network operator provider. An Integrated Circuit Card Identity (ICCID) SIM serial number may be printed on the SIM card for identification.

The MSMS communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The memory 214 may be a non-transitory computer-readable storage medium that stores processor-executable instructions. The memory 214 may store an operating system (OS), as well as user application software and executable instructions. The memory 214 may also store application data, such as an array data structure.

The general-purpose processor 206 may be coupled to a modem 230. The modem 230 may include at least one baseband modem processor 216, which may be coupled to a memory 222 and a modulator/demodulator 228. The baseband modem processor 216 may include physically or logically separate baseband modem processors (e.g., BB1, BB2). The modulator/demodulator 228 may receive data from the baseband modem processor 216 and may modulate a carrier signal with encoded data and provide the modulated signal to one or more RF resources 218a, 218b for transmission. The modulator/demodulator 228 may also extract an information-bearing signal from a modulated carrier wave received from the one or more RF resources 218a, 218b, and may provide the demodulated signal to the baseband modem processor 216. The modulator/demodulator 228 may be or include a digital signal processor (DSP).

The baseband modem processor 216 may read and write information to and from the memory 222. The memory 222 may also store instructions associated with a protocol stack, such as protocol stack S1 222a and protocol stack S2 222b. The protocol stacks S1 222a, S2 222b generally include computer executable instructions to enable communication using a radio access protocol or communication protocol. Each protocol stack S1 222a, S2 222b typically includes network protocol layers structured hierarchically to provide networking capabilities. The modem 230 may include one or more of the protocol stacks S1 222a, S2 222b to enable communication using one or more RATs. The protocol stacks S1 222a, S2 222b may be associated with a SIM card (e.g., SIM-1 204a, SIM-2 204b) configured with a subscription. For example, the protocol stack S1 222a and the protocol stack S2 222b may be associated with the SIM-1 204a. The illustration of only two protocol stacks S1 222a, S2 222b is not intended as a limitation, and the memory 222 may store more than two protocol stacks (not illustrated).

Each SIM and/or RAT in the MSMS communication device 200 (e.g., SIM-1 204a, SIM-2 204b) may be coupled to the modem 230 and may be associated with or permitted to use an RF resource. The term “RF resource chain” may be used to refer to all of the circuitry used to send and receive RF signals, which may include the baseband modem processor 216 that performs baseband/modem functions for communicating with/controlling a RAT, one or more radio units including transmitter and receiver components that are shown as RF resources 218a, 218b (e.g., in FIG. 2), one or more of the wireless antennas 220a, 220b, and additional circuitry that may include one or more amplifiers and radios. The term “Rx chain” may be used to refer to a portion of an RF resource chain that may receive RF signals, and the term “Tx chain” may be used to refer to a portion of an RF resource that may transmit RF signals. The MSMS communication device may include one or more Rx chains and one or more TX chains. In some embodiments, an RF resource may share a common baseband modem processor 216 (i.e., a single device that performs baseband/modem functions for all RATs on the MSMS communication device). In some embodiments, each RF resource may include the physically or logically separate baseband processors (e.g., BB1, BB2).

The RF resources 218a, 218b may include transceivers associated with one or more RATs and may perform transmit/receive functions for the MSMS communication device 200 on behalf of the respective RATs. The RF resources 218a, 218b may include separate transmit and receive circuitry. In some embodiments, the RF resource 218b may include only receive circuitry. The RF resources 218a, 218b may each be coupled to a wireless antenna (e.g., the first wireless antenna 220a and the second wireless antenna 220b). The RF resources 218a, 218b may also be coupled to the modem 230 (e.g., via the modulator/demodulator 228, the baseband modem processor 216, or another component).

In some embodiments, the general-purpose processor 206, memory 214, baseband processor(s) 216, and the RF resources 218a, 218b may be included in the MSMS communication device 200 as a system-on-chip. In some embodiments, the first and second SIMs 204a, 204b and corresponding interfaces 202a, 202b may be external to the system-on-chip. Further, various input and output devices may be coupled to components on the system-on-chip, such as interfaces or controllers. Example user input components suitable for use in the MSMS communication device 200 may include, but are not limited to, a keypad 224 and a touchscreen display 226.

In some embodiments, the keypad 224, the touchscreen display 226, the microphone 212, or a combination thereof may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the MSMS communication device 200 to enable communications.

Functioning together, the two SIMs 204a, 204b, the baseband processor(s) 216, RF resources 218a, 218b and the antennas 220a, 220b may enable communications on two or more RATs. For example, one SIM, baseband processor and RF resource may be configured to support two different RATs. In other embodiments, more RATs may be supported on the MSMS communication device 200 by adding more SIM cards, SIM interfaces, RF resources, and antennas for connecting to additional mobile networks.

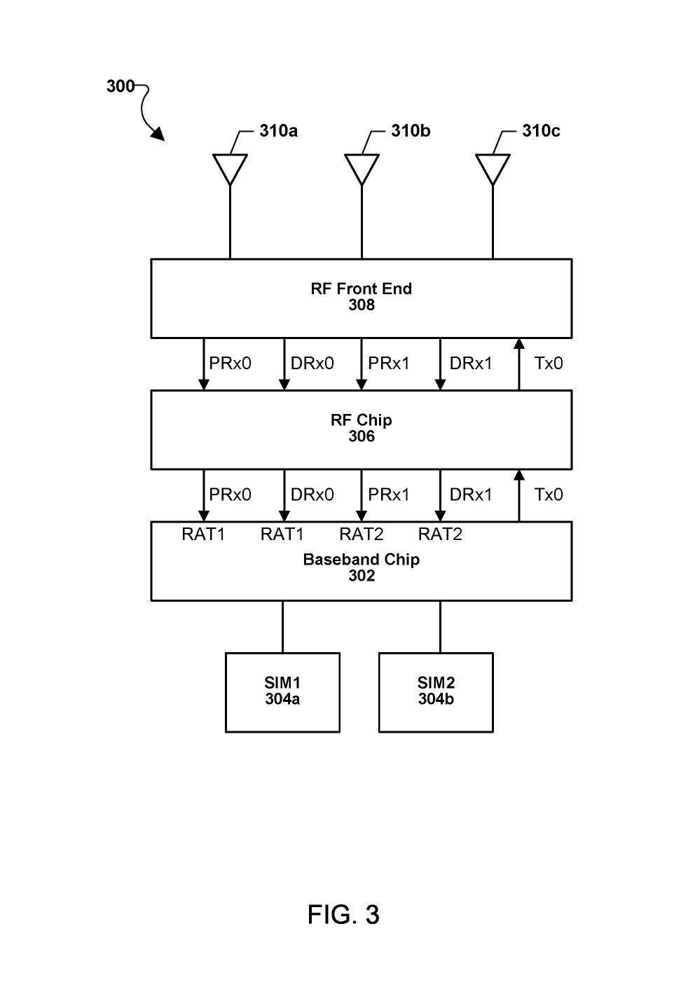

FIG. 3 is a component block diagram of an MSMS communication device 300 suitable for implementing various embodiments. With reference to FIGS. 1-3, in various embodiments, the MSMS communication device 300 may be similar to MSMS communication devices 102 and 200. The MSMS communication device 200 may include a baseband chip 302, and RF chip 306, and an RF front end 308.

The RF front end 308 may include circuitry to transmit and/or receive RF signals from one or more antennas 310a-310c, and to process a received signal at an incoming radio frequency. The RF front end 308 may also include one or more of impedance matching circuitry, a bandpass filter, and RF signal amplifier, and a mixer to mix one or more signals. The RF front end 308 may provide one or more RF signals to the RF chip 306 using a first Rx chain with two receive paths (e.g., a Primary Receive 0 (PRx0) and a Diversity Receive 0 (DRx0)), for Multiple Input, Multiple Output (MIMO) or diversity reception, and/or a second Rx chain with two receive paths (e.g., a Primary Receive 1 (PRx1) and a Diversity Receive 1 (DRx1)), which may also support MIMO or diversity reception. The RF front end 308 may also receive one or more signals for transmission from the RF chip 306 using a transmit chain (e.g., Tx0).

The RF chip 306 may include circuitry to downconvert one or more signals that the RF chip 306 receives via the RF front end 308, as well as to upconvert one or more signals that the RF chip 306 provides to the RF front end 308 for transmission. The RF chip 306 may provide one or more RF signals to the baseband chip 302 using the first Rx chain (e.g., PRx0 and DRx0), and/or the second Rx chain (e.g., PRx1 and DRx1). The RF chip 306 may also receive one or more signals for transmission from the baseband chip 302 using the transmit chain.

The baseband chip 302 may include circuitry to perform signal processing and to implement real-time radio transmission operations of the MSMS communication device. In some embodiments, the baseband chip 302 may execute a real-time operating system (RTOS), and may perform RF signal processing operations including signal modulation, encoding and/or decoding, radio frequency shifting, and other such operations. The baseband chip 302 may communicate with one or more SIM cards, such as SIM1 304a and SIM2 304b. The baseband chip 302 may also enable or disable access by the one or more SIM cards to the first Rx chain and/or the second Rx chain, as well as to the Tx chain. In some embodiments, the functions of one or more of the RF front end 308 the RF chip 306 and the baseband chip 302 may be performed using digital signal processing circuitry.

The MSMS communication device 300 may operate in one or more receive modes to receive RF signals. For example, when operating in full concurrency mode, the MSMS communication device may use the first Rx chain with two receive paths (e.g., PRx0 and DRx0) to receive a first signal associated with a first subscription, and a second Rx chain with two receive paths (e.g., PRx1 and DRx1) to receive a second signal associated with a second subscription. The first subscription may be associated with, for example, a first SIM (e.g., the SIM1 304a). In some embodiments, the first signal may use a first radio access technology (e.g., RAT1). The second subscription may be associated with, for example, a second SIM (e.g., the SIM2 304b). In some embodiments, the second signal may use a second radio access technology (e.g., RAT2).

As another example, when operating in diversity sharing mode, the MSMS communication device may use the first Rx chain (e.g., PRx0 and DRx0), to receive the first signal (associated with the first subscription) while the second subscription is not in active use (e.g., when the second subscription is in an idle mode). The MSMS communication device may perform a tune-away with the second Rx chain with only the diversity path, i.e. DRx1, to perform communication activities for the second subscription, such as page monitoring, neighboring cell measurements, and other communication activities. During the tune-away, the first subscription may lose access to the diversity receive path, i.e. DRx0, but retain primary receive path, i.e. PRx0.

As another example, when operating in hybrid fallback mode, the MSMS communication device may perform a tune-away with the second Rx chain and with the Tx chain to perform communication activities for the second subscription. During the tune-away, the first subscription may lose access to the first Rx chain, i.e. PRx0 and DRx0.

In various embodiments, the MSMS communication device may transition receive operating modes among full concurrency, diversity sharing, and hybrid fallback modes. For example, the MSMS communication device may monitor a signal level (e.g., signal strength, and/or signal quality) of a paging channel (PCH) of the second subscription, and the device processor may select one of the receive operating modes based on the signal level of the second subscription paging channel Based on the selected receive operating mode, the MSMS communication device may grant the first subscription access to one or more paths of one or more Rx chains. For example, when the PCH signal level is high (e.g., above a first threshold), the MSMS communication device may select the full concurrency mode and grant the first subscription access to both paths of the first and second Rx chains (e.g., PRx0, DRx0, PRx1, and PRx2). Alternatively, the MSMS communication device may select the diversity sharing mode and grant the first subscription access to the first Rx chain and to one path of the second Rx chain (e.g., PRx0, DRx0, and PRx1), while granting the second subscription access to one path of the second Rx (e.g., DRx1) to perform communication activities for the second subscription (e.g., during a tune-away). As the second subscription PCH signal level degrades (e.g., falls below the first threshold, but above a second threshold), the MSMS communication device may switch to using the hybrid fallback mode and grant the first subscription access to only the first Rx chain (e.g., PRx0 and DRx0) while granting the second subscription access to the second Rx chain (e.g., PRx1 and DRx1) as well as the TX chain.

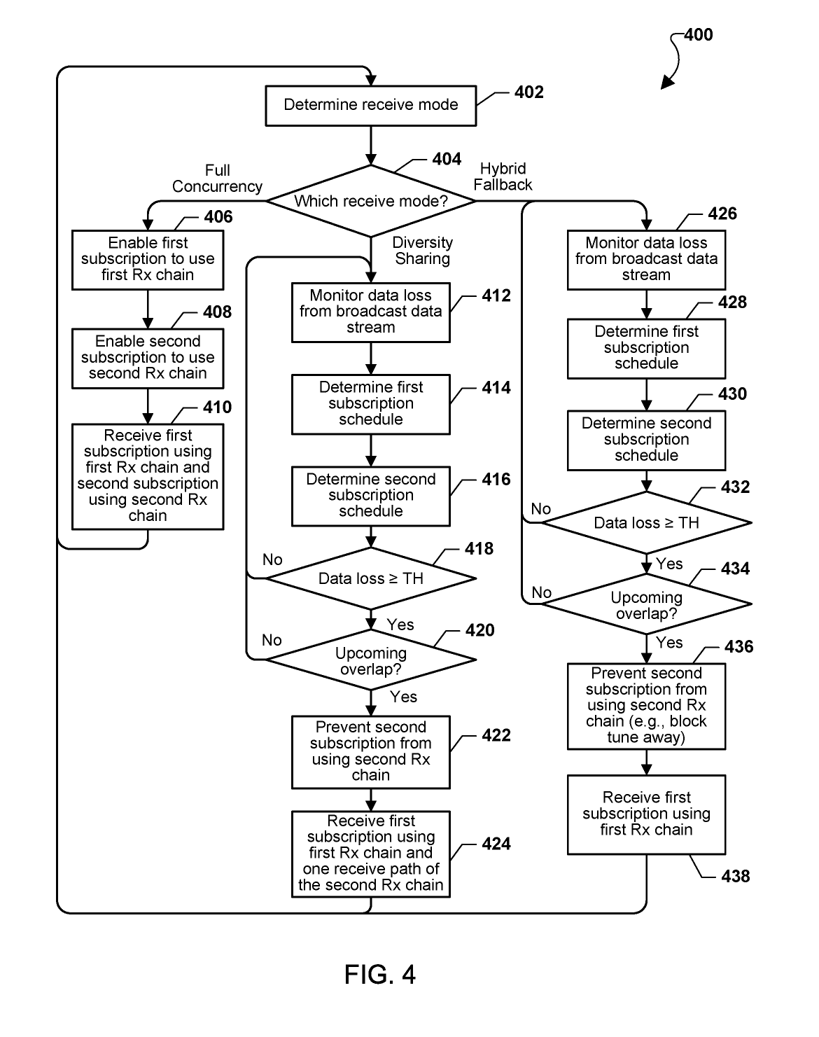

FIG. 4 illustrates a method 400 for managing access to a first receive chain and a second receive chain of a multi-subscription multi-standby communication device according to some embodiments. With reference to FIGS. 1-4, the method 400 may be implemented by an MSMS communication device (e.g., the MSMS communication device 102, 200, 300), such as under the control of a processor (e.g., the general-purpose processor 206, the baseband processor 216, a separate controller, and/or the like) of the MSMS communication device (i.e., a device processor).

In block 402, the device processor may determine a receive mode of the MSMS communication device (i.e., a receive mode in which the MSMS communication device is currently operating). In some embodiments, the MSMS communication device may currently be receiving a broadcast data stream. In determination block 404, the device processor may determine whether the MSMS communication device is operating in full concurrency mode, diversity sharing mode, or hybrid fallback mode.

In response to determining that the MSMS communication device is operating in full concurrency mode (i.e., determination block 404=“Full Concurrency”), the device processor may enable a first subscription to use a first Rx chain of the MSMS communication device in block 406, and the device processor may enable a second subscription to use a second Rx chain of the MSMS communication device in block 408. Thus, the device processor may enable the first subscription and the second subscription to receive signals concurrently.

In block 410, the device processor may receive a signal of the first subscription using the first Rx chain (i.e., the device processor may perform a first communication activity using the first Rx chain), and the device processor may receive a second signal of the second subscription using the second Rx chain (i.e., the device processor may perform a second communication activity using the second Rx chain concurrently). Periodically, the device processor may again determine a receive mode of the MSMS communication device in block 402 and repeat the operations of the method 400.

In response to determining that the MSMS communication device is operating in diversity sharing mode (i.e., determination block 404=“Diversity Sharing”), the device processor may monitor an amount of data loss from the broadcast data stream in block 412. In some embodiments, the device processor may monitor the amount of data loss on the basis of a segment or another discrete portion of the broadcast data stream.

In block 414, the device processor may determine a communication activity schedule of the first subscription. For example, the device processor may determine a timing of a first communication activity of the MSMS communication device using the first subscription. In some embodiments, the first communication activity may include receiving broadcast data in the MSMS communication device from the first subscription. In some embodiments, the device processor may determine a timing of reception of one or more segments or other portions of the broadcast data stream by the MSMS communication device.

In block 416, the device processor may determine a schedule of the second subscription. For example, the device processor may determine a timing of a second communication activity of the MSMS communication device using the second subscription. In some embodiments, the second communication activity may include monitoring the second subscription for a paging message, performing signal measurements using the second subscription, or another communication activity.

In determination block 418, the device processor may determine whether the data loss from the broadcast data stream is greater than or equal to a data loss threshold. This data loss threshold may be determined based on an amount of data that may be lost while still enabling full recovery of the data stream using the embedded error correction information. In response to determining that the data loss is not greater than or equal to the data loss threshold (i.e., determination block 418=“No”), the device processor may continue to monitor the data loss from the broadcast data stream in block 412.

In response to determining that the data loss is greater than or equal to the data loss threshold (i.e., determination block 418=“Yes”), the device processor may determine whether there is an upcoming overlap in time (a collision) between a communication activity (e.g., broadcast data reception) of the first subscription and a communication activity (e.g., page monitoring) of the second subscription in determination block 420. In some embodiments, the overlap in time of communication activities by the first and second subscriptions may include an overlap of a reception of a broadcast data stream using the first subscription and a scheduled reception of a signal using the second subscription. In response to determining that there is no upcoming overlap in subscription communication activities (i.e., determination block 420=“No”), the device processor may continue to monitor the data loss from the broadcast data stream in block 412.

In response to determining that there is an upcoming overlap between the reception activities of the first subscription and the second subscription (i.e., determination block 420=“Yes”), the device processor may prevent the second subscription from using the second Rx chain during the overlap in block 422. In some embodiments, preventing the second subscription from using the second Rx chain during the overlap may retain one of the receive paths of the second Rx chain (e.g., PRx1 or DRx1) for use by the first subscription, as well as using both receive paths of the first chain (e.g., PRx0 and DRx0) for receiving the first communication activity of the first subscription (e.g., receiving the broadcast data stream).

In block 424, the device processor may receive the first subscription (i.e., the device processor may perform the first communication activity) using the first Rx chain with two receive paths. In some embodiments, the device processor may receive the first subscription using the first Rx chain and one receive path of the second Rx chain (e.g., Prx1 or DRx1). Periodically, the device processor may again determine a receive mode of the MSMS communication device in block 402 and repeat the operations of the method 400.

In response to determining that the MSMS communication device is operating in hybrid fallback mode (i.e., determination block 404=“Hybrid Fallback”), the device processor may monitor an amount of data loss from the broadcast data stream in block 426. In some embodiments, the device processor may monitor the amount of data loss on the basis of a segment or another discrete portion of the broadcast data stream.

In block 428, the device processor may determine a schedule of communication activities of the first subscription. For example, the device processor may determine a timing of a first communication activity of the MSMS communication device using the first subscription. In some embodiments, the first communication activity may include reception of broadcast data by the MSMS communication device from the first subscription. In some embodiments, the device processor may determine a timing of reception of one or more segments or other portions of the broadcast data stream by the MSMS communication device.

In block 430, the device processor may determine a schedule of communication activities by the second subscription. For example, the device processor may determine a timing of a second communication activity of the MSMS communication device using the second subscription. In some embodiments, the second communication activity may include monitoring the second subscription for a paging message, performing signal measurements using the second subscription, or another communication activity.

In determination block 432, the device processor may determine whether the data loss from the broadcast data stream is greater than or equal to a data loss threshold. In response to determining that the data loss is not greater than or equal to the data loss threshold (i.e., determination block 432=“No”), the device processor may continue to monitor the data loss from the broadcast data stream in block 426.

In response to determining that the data loss is greater than or equal to the data loss threshold (i.e., determination block 432=“Yes”), the device processor may determine whether there is an upcoming overlap in time between a communication activity of the first subscription and a communication activity of the second subscription in determination block 434. In some embodiments, the overlap in time of communication activities may include an overlap of a reception of a broadcast data stream using the first subscription and a scheduled reception of a signal using the second subscription. In response to determining that there is no upcoming overlap in communication activities (i.e., determination block 434=“No”), the device processor may return to block 426, and the device processor may continue to monitor the data loss from the broadcast data stream in block 426.

In response to determining that there is an upcoming overlap between the reception activities of the first subscription and the second subscription (i.e., determination block 434=“Yes”), the device processor may prevent the second subscription from using the second Rx chain during the overlap in block 436. In some embodiments, preventing the second subscription from using the second Rx chain during the overlap may include blocking or preventing a tune-away to the second subscription. In some embodiments, preventing the second subscription from using the second Rx chain during the overlap may retain both receive paths of the first chain (e.g., PRx0 and DRx0) for receiving the first communication activity of the first subscription (e.g., receiving the broadcast data stream).

In block 438, the device processor may receive the first subscription (i.e., the device processor may perform the first communication activity) using first Rx chain. Periodically, the device processor may again determine a receive mode of the MSMS communication device in block 402 and repeat the operations of the method 400.

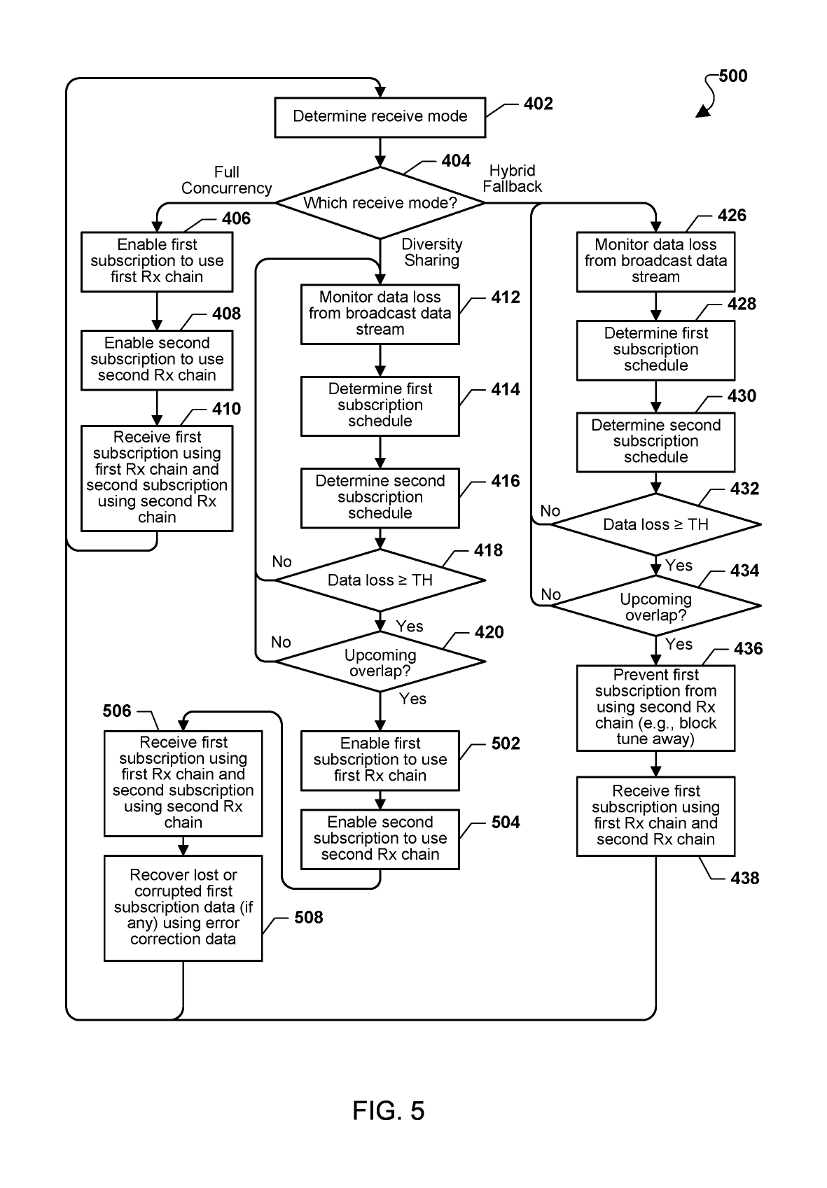

FIG. 5 illustrates a method 500 for managing access to a first receive chain and a second receive chain performed by a MSMS communication device according to some embodiments. With reference to FIGS. 1-5, the method 500 may be implemented by an MSMS communication device (e.g., the MSMS communication device 102, 200, 300), such as under the control of a processor (e.g., the general-purpose processor 206, the baseband processor 216, a separate controller, and/or the like) of the MSMS communication device (i.e., a device processor). In blocks 402-438, the device processor may perform operations of like-numbered blocks of the method 400 as described.

In determination block 418, the device processor may determine whether the data loss from the broadcast data stream is greater than or equal to a data loss threshold. In response to determining that the data loss is not greater than or equal to the data loss threshold (i.e., determination block 418=“No”), the device processor may continue to monitor the data loss from the broadcast data stream in block 412.

In response to determining that the data loss is greater than or equal to the data loss threshold (i.e., determination block 418=“Yes”), the device processor may determine whether there is an upcoming overlap in time between a communication activity of the first subscription and a communication activity of the second subscription in determination block 420.

In response to determining that there is an upcoming overlap in communication activities of the first subscription and the second subscription (i.e., determination block 420=“Yes”), the device processor may enable the first subscription to use the first Rx chain of the MSMS communication device in block 502. In some embodiments, the first subscription may use a primary receive path (e.g., PRx0). In some embodiments, the device processor may use error correction data to recover lost or corrupted data from the first subscription (for example, from a broadcast data stream). In some embodiments, the communication network may provide additional error correction data (e.g., forward error correction (FEC) data) in data to be received by the first subscription to recover lost or corrupted data when data loss may be greater than or equal to the data loss threshold.

In block 504, the device processor may enable the second subscription to use the second Rx chain of the MSMS communication device. In some embodiments, the device processor may enable the second subscription to use at least the diversity receive path (e.g., DRx1) of the MSMS communication device. Thus, the device processor may enable the first subscription and the second subscription to receive signals concurrently.

In block 506, the MSMS communication device may receive a signal of the first subscription using the first Rx chain (i.e., the device processor may perform a first communication activity using the first Rx chain (e.g., the primary receive path PRx0), and receive a second signal of the second subscription using the second Rx chain (i.e., the device processor may perform a second communication activity using the second Rx chain diversity receive path (e.g., DRx1)).

In block 508, the device processor may recover lost or corrupted first subscription data, if any, using the error correction data. Periodically, the device processor may again determine a receive mode of the MSMS communication device in block 402 and repeat the operations of the method 500.

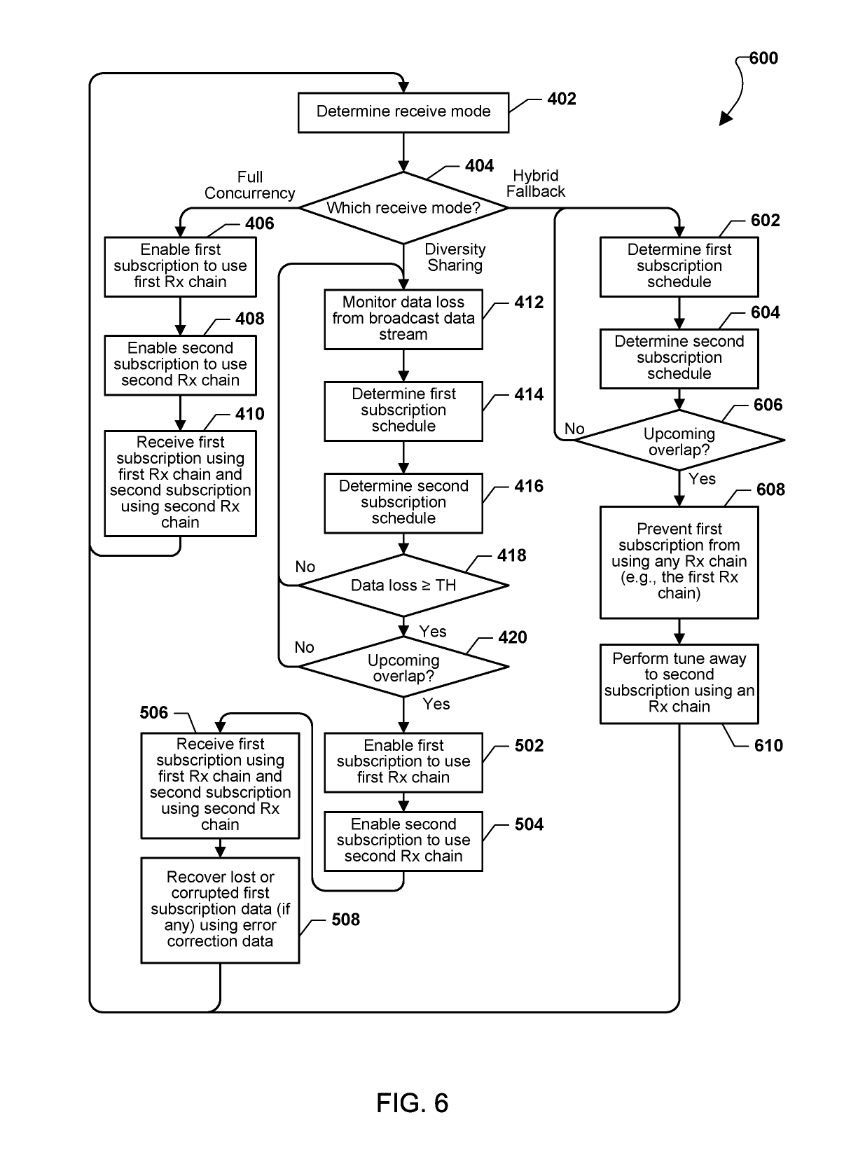

FIG. 6 illustrates a method 600 for managing access to a first receive chain and a second receive chain performed by a MSMS communication device according to some embodiments. With reference to FIGS. 1-6, the method 600 may be implemented by an MSMS communication device (e.g., the MSMS communication device 102, 200, 300), such as under the control of a processor (e.g., the general-purpose processor 206, the baseband processor 216, a separate controller, and/or the like) of the MSMS communication device (i.e., a device processor). In blocks 402-510, the device processor may perform operations of like-numbered blocks of the methods 400 and 500 as described.

In response to determining that the MSMS communication device is operating in hybrid fallback mode (i.e., determination block 404=“Hybrid Fallback”), the device processor may determine a schedule of communication activities of the first subscription in block 602. For example, the device processor may determine a timing of a first communication activity of the MSMS communication device using the first subscription. In some embodiments, the first communication activity may include reception of data by the MSMS communication device from the first subscription. In some embodiments, the device processor may determine a timing of reception of one or more segments or other portions of the broadcast data stream by the MSMS communication device.

In block 604, the device processor may determine a schedule of communication activities of the second subscription. For example, the device processor may determine a timing of a second communication activity of the MSMS communication device using the second subscription.

In determination block 606, the device processor may determine whether there is an upcoming overlap in time between a communication activity of the first subscription and a communication activity of the second subscription. In some embodiments, the overlap in time of communication activities may include an overlap of a reception of a broadcast data stream using the first subscription and a scheduled reception of a signal using the second subscription. In response to determining that there is no upcoming overlap (i.e., determination block 606=“No”), the device processor may continue to monitor the data loss from the broadcast data stream in block 602.

In response to determining that there is an upcoming overlap between the reception activities of the first subscription and the second subscription (i.e., determination block 606=“Yes”), the device processor may prevent the first subscription from using any Rx chain of the MSMS communication device in block 608. For example, the device processor may prevent the first subscription from using the first Rx chain. In some embodiments, the device processor may prevent or block reception of the broadcast data stream using the first subscription, and enable the second subscription to perform a scheduled reception of a signal of the second subscription. In some embodiments, the device processor may enable the second subscription to perform a tune-away (i.e., the device processor may enable the performance of a tune-away to the second subscription) while blocking reception of broadcast data by the first subscription for the duration of the tune-away.

In block 610, the device processor may perform a tune-away to the second subscription. For example, the device processor may perform a tune-away using the first Rx chain or the second Rx chain. Periodically, the device processor may again determine a receive mode of the MSMS communication device in block 402 and repeat the operations of the method 600.

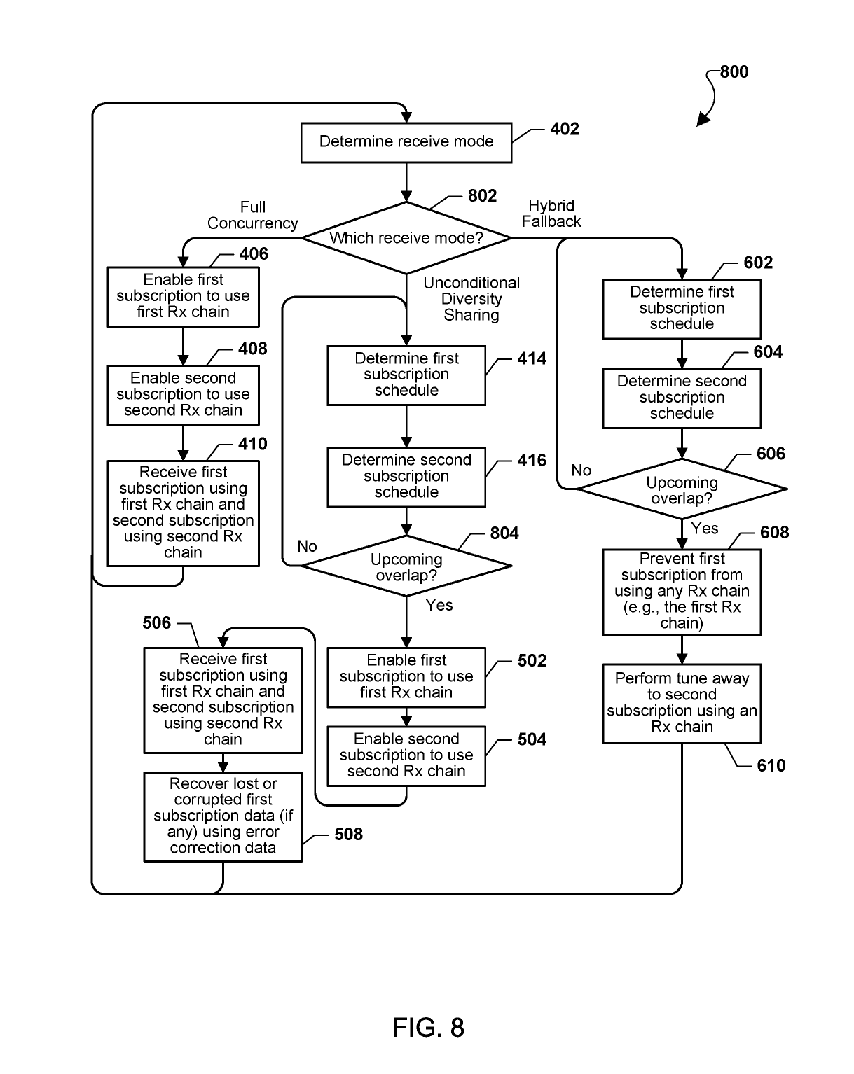

FIG. 8 illustrates a method 800 for managing access to a first receive chain and a second receive chain of a multi-subscription multi-standby communication device according to some embodiments. With reference to FIGS. 1-6 and 8, the method 800 may be implemented by an MSMS communication device (e.g., the MSMS communication device 102, 200, 300), such as under the control of a processor (e.g., the general-purpose processor 206, the baseband processor 216, a separate controller, and/or the like) of the MSMS communication device (i.e., a device processor). In blocks 402-416, 502-508, and 602-610, the device processor may perform operations of like numbered blocks of the methods 400, 500, and 600 discussed in more detail above with reference to FIGS. 4-6.

In determination block 802, the device processor may determine whether the MSMS communication device is operating in full concurrency mode, an unconditional diversity sharing mode, or hybrid fallback mode. In some embodiments, the unconditional diversity sharing mode may include operations performed without reference to or use of a data loss threshold.

In response to determining that the MSMS communication device is operating in unconditional diversity sharing mode (i.e., determination block 802=“Unconditional Diversity Sharing”), the device processor may perform the operations of blocks 414, and 416, as described above (FIG. 4).

In determination block 804, the device processor may determine whether there is an upcoming overlap in time (a collision) between a communication activity (e.g., broadcast data reception) of the first subscription and a communication activity of the second subscription. In some embodiments, the overlap in time of communication activities by the first and second subscriptions may include an overlap of a reception of a broadcast data stream using the first subscription and a scheduled reception of a signal using the second subscription. In various embodiments, the device processor may determine whether there is an upcoming overlap in time without reference to or use of a data loss threshold.

In some embodiments, the device processor may determine whether there is an upcoming overlap in time during which the communication activity of the second subscription may include performing an idle mode procedure, such as monitoring paging, performing a location area update, performing a search for a higher priority network (e.g., a public land mobile network (PLMN) search), acquiring system information, and the like. For example, the device processor may determine whether there is an upcoming overlap, and the device processor may determine that the performance of one or more idle mode procedures is required. In some embodiments, the device processor may determine the second subscription activities based on the second subscription schedule.

In response to determining that there is no upcoming overlap in subscription communication activities (i.e., determination block 804=“No”), the device processor may again determine a communication activity schedule of the first subscription in block 414.

In response to determining that there is an upcoming overlap between the reception activities of the first subscription and the second subscription (i.e., determination block 804=“Yes”), the device processor may perform the operations of blocks 502-508 (FIG. 5).

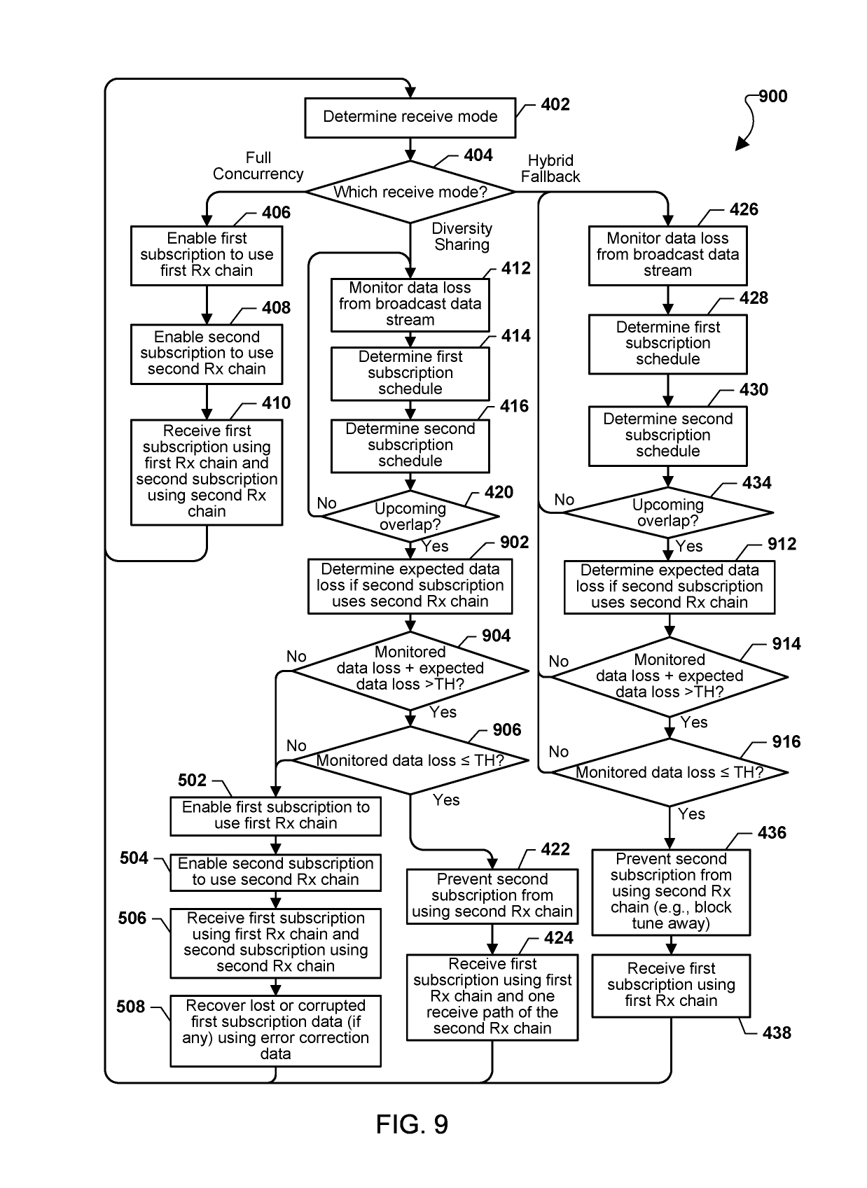

FIG. 9 illustrates a method 900 for managing access to a first receive chain and a second receive chain of a multi-subscription multi-standby communication device according to some embodiments. With reference to FIGS. 1-6, 8, and 9, the method 900 may be implemented by an MSMS communication device (e.g., the MSMS communication device 102, 200, 300), such as under the control of a processor (e.g., the general-purpose processor 206, the baseband processor 216, a separate controller, and/or the like) of the MSMS communication device (i.e., a device processor). In blocks 402-438, the device processor may perform operations of like numbered blocks of the method 400 as discussed in more detail above with reference to FIG. 4.

In some embodiments, device processor may dynamically determine whether to enable the second subscription to use the second Rx chain. For example, based on the data loss of a current segment or other discrete portion from the broadcast stream and an expected amount of data loss of a next segment or portion of the broadcast data stream (e.g., of a next segment/burst of the broadcast data, such as a next eMBMS burst) that may occur from the broadcast stream if the second subscription is enabled to use the second Rx chain, the device processor may determine whether to enable or to prevent the second subscription from using the second Rx chain.

In some embodiments, in response to determining that there is an upcoming overlap between the reception activities of the first subscription and the second subscription (i.e., determination block 420=“Yes”), the device processor may determine an expected data loss if the second subscription uses the second Rx chain (i.e., during the upcoming overlap) in block 902.

In determination block 904, the device processor may determine whether the monitored the data loss (e.g., of a current segment of the broadcast data) plus the expected data loss (e.g., a next eMBMS burst) is greater than a threshold (TH). In some embodiments, the device processor may determine a threshold based on an expected amount of data in the broadcast data stream. In some embodiments, the expected amount of data may include an expected amount of data in a segment of the broadcast data stream (e.g., a size (e.g., in bytes) of a segment or of another discrete portion of the broadcast data stream). In some embodiments, the expected amount of data may include an expected amount of content data in the segment or other discrete broadcast data stream portion. In some embodiments, the expected amount data may include an amount of error correction data (e.g., FEC data). In some embodiments, the device processor may determine the threshold based on a segment size and an amount of error correction data. For example, in some embodiments, the device processor may determine the threshold TH according to the following equation:

TH=SegSize*(FEC %−3%) [Equation 1]

in which SegSize represents a size of the segment or other discrete broadcast data stream portion, and FEC % represents an amount of error correction data in the segment (or other discrete portion). In some embodiments, a value (such as the indicated 3%) may be included to represent a minimum amount of error correction data that may be included in the broadcast data stream (e.g., as may be required by an FEC algorithm, such as Raptor).

In response to determining that the monitored the data loss plus the expected data loss is greater than a threshold (i.e., determination block 904=“Yes”), the device processor may determine whether the monitored data loss is less than or equal to the threshold in determination block 906.

In response to determining that the monitored data loss is less than or equal to the threshold (i.e., determination block 906=“Yes”), the device processor may prevent the second subscription from using the second Rx chain during the overlap in block 422. In some embodiments, preventing the second subscription from using the second Rx chain during the overlap may retain one of the receive paths of the second Rx chain (e.g., PRx1 or DRx1) for use by the first subscription, as well as using both receive paths of the first chain (e.g., PRx0 and DRx0) for receiving the first communication activity of the first subscription (e.g., receiving the broadcast data stream).

In response to determining that the monitored the data loss plus the expected data loss is not greater than a threshold (i.e., determination block 904=“No”), and in response to determining that that the monitored data loss is not less than or equal to the threshold (i.e., determination block 906=“No”), the device processor may perform the operations of blocks 502-508. For example, in the event that the monitored data loss plus the expected data loss is below the threshold, the second subscription may be enabled to use the second Rx chain without substantially degrading reception of the broadcast data stream. As another example, in the event that the monitored data loss is greater than threshold, the amount of data loss from the broadcast data stream is so great that the device processor will be unable to recover the segment. In such case, the device processor may enable the second subscription to use the second Rx chain since segment is already unrecoverable.

In response to determining that there is an upcoming overlap between the reception activities of the first subscription and the second subscription (i.e., determination block 434=“Yes”), the device processor may determine an expected data loss if the second subscription uses the second Rx chain (i.e., during the upcoming overlap) in block 912.

In determination block 914, the device processor may determine whether the monitored the data loss (e.g., of a current segment of the broadcast data) plus the expected data loss (e.g., a next eMBMS burst) is greater than a threshold (TH). In some embodiments, the operations performed by the device processor in determination block 914 may be similar to the operations of determination block 904 discussed above.

In response to determining that the monitored the data loss plus the expected data loss is greater than a threshold (i.e., determination block 904=“Yes”), the device processor may determine whether the monitored data loss is less than or equal to the threshold in determination block 906.

In response to determining that the monitored data loss is less than or equal to the threshold (i.e., determination block 906=“Yes”), the device processor may prevent the second subscription from using the second Rx chain during the overlap in block 436. In some embodiments, preventing the second subscription from using the second Rx chain during the overlap may retain one of the receive paths of the second Rx chain (e.g., PRx1 or DRx1) for use by the first subscription, as well as using both receive paths of the first chain (e.g., PRx0 and DRx0) for receiving the first communication activity of the first subscription (e.g., receiving the broadcast data stream).

In response to determining that the monitored the data loss plus the expected data loss is not greater than a threshold (i.e., determination block 914=“No”), and in response to determining that that the monitored data loss is not less than or equal to the threshold (i.e., determination block 916=“No”), the device processor may continue to monitor the data loss from the broadcast data stream in block 426.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 400, 500, 600, 800, and 900, may be substituted for or combined with one or more operations of the methods 400, 500, 600, 800, and 900, and vice versa.

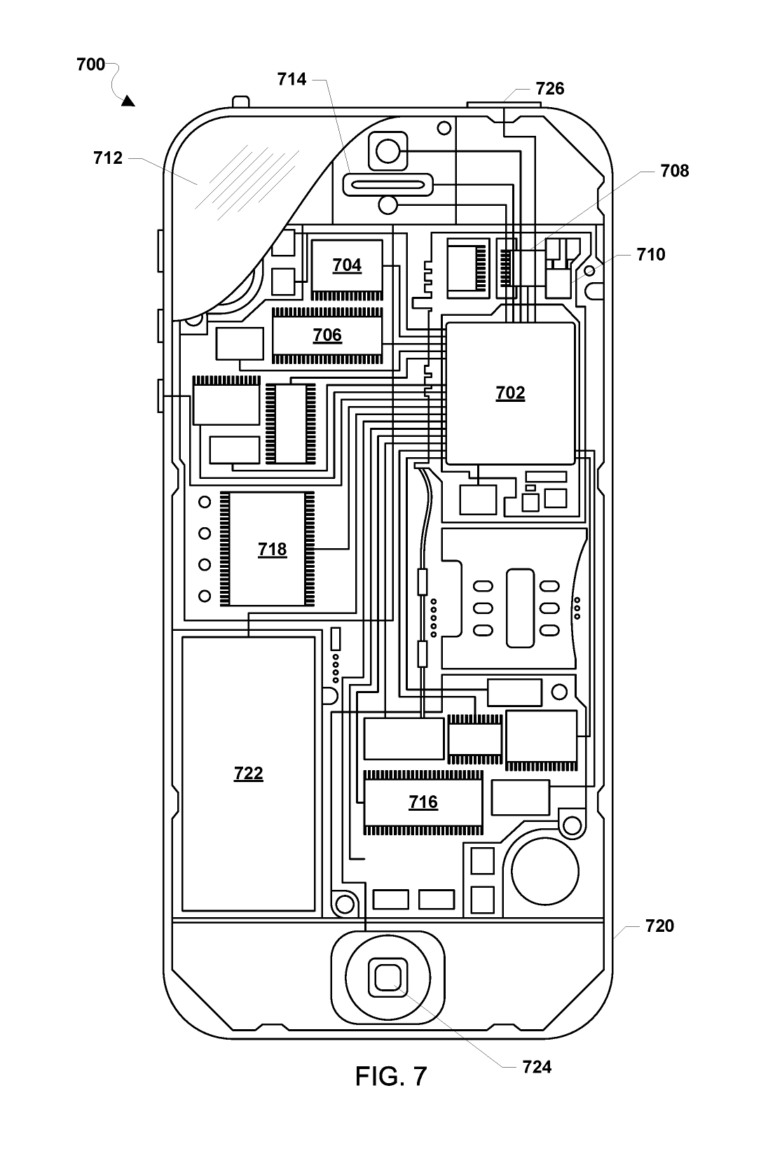

Various embodiments (including, but not limited to, embodiments described with reference to FIGS. 1-6, 8, and 9 may be implemented in any of a variety of MSMS communication devices, an example of which (e.g., MSMS communication device 700) is illustrated in FIG. 7. With reference to FIGS. 1-9, in various embodiments, the MSMS communication device 700 (which may correspond, for example, to the MSMS communication devices 102, 200, and 300) may include a processor 702 coupled to a touchscreen controller 704 and an internal memory 706. The processor 702 may be one or more multi-core integrated circuits designated for general or specific processing tasks. The internal memory 706 may be volatile or non-volatile memory, and may also be secure and/or encrypted memory, or unsecure and/or unencrypted memory, or any combination thereof. The touchscreen controller 704 and the processor 702 may also be coupled to a touchscreen panel 712, such as a resistive-sensing touchscreen, capacitive-sensing touchscreen, infrared sensing touchscreen, etc. Additionally, the display of the MSMS communication device 700 need not have touch screen capability.

The MSMS communication device 700 may have two or more radio signal transceivers 708 (e.g., Peanut, Bluetooth, ZigBee, Wi-Fi, RF radio) and antennae 710, for sending and receiving communications, coupled to each other and/or to the processor 702. The transceivers 708 and antennae 710 may be used with the above-mentioned circuitry to implement the various wireless transmission protocol stacks and interfaces. The MSMS communication device 700 may include one or more cellular network wireless modem chip(s) 716 coupled to the processor and antennae 710 that enable communication via two or more cellular networks via two or more radio access technologies.

The MSMS communication device 700 may include a peripheral device connection interface 718 coupled to the processor 702. The peripheral device connection interface 718 may be singularly configured to accept one type of connection, or may be configured to accept various types of physical and communication connections, common or proprietary, such as USB, FireWire, Thunderbolt, or PCIe. The peripheral device connection interface 718 may also be coupled to a similarly configured peripheral device connection port (not shown).

The MSMS communication device 700 may also include speakers 714 for providing audio outputs. The MSMS communication device 700 may also include a housing 720, constructed of a plastic, metal, or a combination of materials, for containing all or some of the components discussed herein. The MSMS communication device 700 may include a power source 722 coupled to the processor 702, such as a disposable or rechargeable battery. The rechargeable battery may also be coupled to the peripheral device connection port to receive a charging current from a source external to the MSMS communication device 700. The MSMS communication device 700 may also include a physical button 724 for receiving user inputs. The MSMS communication device 700 may also include a power button 726 for turning the MSMS communication device 700 on and off.

The processor 702 may be any programmable microprocessor, microcomputer or multiple processor chip or chips that can be configured by software instructions (applications) to perform a variety of functions, including the functions of various embodiments described below. In some MSMS communication devices, multiple processors 702 may be provided, such as one processor dedicated to wireless communication functions and one processor dedicated to running other applications. Typically, software applications may be stored in the internal memory 706 before they are accessed and loaded into the processor 702. The processor 702 may include internal memory sufficient to store the application software instructions.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the scope of the embodiments. Thus, the various embodiments are not intended to be limited to the embodiments shown herein but are to be accorded the widest scope consistent with the following claims and the principles and novel features disclosed herein.

What is claimed is:

1. A method for managing access to a first receive chain and a second receive chain of a multi-subscription multi-standby (MSMS) communication device by a plurality of subscriptions of the MSMS communication device during receipt of a broadcast data stream, comprising:
determining a receive mode of the MSMS communication device; and
in response to determining that the receive mode is a diversity sharing mode:
determining a schedule of communication activity of a first subscription (first subscription schedule) and a schedule of communication activity of a second subscription (second subscription schedule);
determining whether there is an upcoming overlap between the first subscription schedule and the second subscription schedule; and
preventing the second subscription from using a first receive path of the second receive chain in response to determining that there is an upcoming overlap between the first subscription schedule and the second subscription schedule.

2. The method of claim 1, further comprising:
receiving the first subscription using the first receive chain and a second receive path of the second receive chain.

3. The method of claim 1, wherein preventing the second subscription from using a first receive path of the second receive chain in response to determining that there is an upcoming overlap between the first subscription schedule and the second subscription schedule comprises:
monitoring a data loss from the broadcast data stream;
determining whether the monitored data loss and an expected data loss exceed a threshold; and
preventing the second subscription from using a first receive path of the second receive chain in response to determining that the monitored data loss and the expected data loss exceeds the threshold.

4. The method of claim 3, further comprising:
enabling the second subscription to use the first receive path of the second receive chain in response to determining that the monitored data loss and the expected data loss does not exceed the threshold.

5. The method of claim 3, wherein preventing the second subscription from using a first receive path of the second receive chain in response to determining that the monitored data loss and the expected data loss exceeds the threshold comprises:
determining whether the monitored data loss is less than or equal to the threshold; and
preventing the second subscription from using a first receive path of the second receive chain in response to determining that the monitored data loss and the expected data loss exceeds the threshold and that the monitored data loss is less than or equal to the threshold.

6. The method of claim 5, further comprising:
enabling the second subscription to use the first receive path of the second receive chain in response to determining that the monitored data loss is not less than or equal to the threshold.

7. A multi-subscription multi-standby (MSMS) communication device, comprising:
a memory;
a radio frequency (RF) resource comprising a transmitter chain, a first receive chain and a second receive chain;
a processor coupled to the memory and the RF resource, and configured with processor-executable instructions to:
determine a receive mode of the MSMS communication device during receipt of a broadcast data stream; and
in response to determining that the receive mode is a diversity sharing mode:
determine a schedule of communication activity of a first subscription (first subscription schedule) and a schedule of communication activity of a second subscription (second subscription schedule);
determine whether there is an upcoming overlap between the first subscription schedule and the second subscription schedule; and
prevent the second subscription from using a first receive path of the second receive chain in response to determining that there is an upcoming overlap between the first subscription schedule and the second subscription schedule.

8. The MSMS communication device of claim 7, wherein the processor is further configured to:
receive the first subscription using the first receive chain and a second receive path of the second receive chain.

9. The MSMS communication device of claim 7, wherein the processor is further configured to:
monitoring a data loss from the broadcast data stream;
determine whether the monitored data loss and an expected data loss exceed a threshold; and
prevent the second subscription from using a first receive path of the second receive chain in response to determining that the monitored data loss and the expected data loss exceeds the threshold.

10. The MSMS communication device of claim 9, wherein the processor is further configured to:
enable the second subscription to use the first receive path of the second receive chain in response to determining that the monitored data loss and the expected data loss does not exceed the threshold.

11. The MSMS communication device of claim 9, wherein the processor is further configured to:
determine whether the monitored data loss is less than or equal to the threshold; and
prevent the second subscription from using a first receive path of the second receive chain in response to determining that the monitored data loss and the expected data loss exceeds the threshold and that the monitored data loss is less than or equal to the threshold.

12. The MSMS communication device of claim 11, wherein the processor is further configured to:
enable the second subscription to use the first receive path of the second receive chain in response to determining that the monitored data loss is not less than or equal to the threshold.

13. A multi-subscription multi-standby (MSMS) communication device, comprising:
means for determining a receive mode of the MSMS communication device during receipt of a broadcast data stream; and
in response to determining that the receive mode is a diversity sharing mode:
means for determining a schedule of communication activity of a first subscription (first subscription schedule) and a schedule of communication activity of a second subscription (second subscription schedule);
means for determining whether there is an upcoming overlap between the first subscription schedule and the second subscription schedule; and
means for preventing the second subscription from using a first receive path of the second receive chain in response to determining that there is an upcoming overlap between the first subscription schedule and the second subscription schedule.

14. A non-transitory processor-readable medium having stored thereon processor-executable instructions configured to cause a processor of a multi-subscription multi-standby (MSMS) communication device having a first receive chain and a second receive chain to perform operations comprising:
determining a receive mode of the MSMS communication device during receipt of a broadcast data stream;
in response to determining that the receive mode is a diversity sharing mode:
monitoring a data loss from the broadcast data stream;
determining a schedule of communication activity of a first subscription (first subscription schedule) and a schedule of communication activity of a second subscription (second subscription schedule);
determining whether there is an upcoming overlap between the first subscription schedule and the second subscription schedule; and
preventing the second subscription from using a first receive path of the second receive chain in response to determining that there is an upcoming overlap between the first subscription schedule and the second subscription schedule.

15. The non-transitory processor-readable medium of claim 14, wherein the stored processor-executable instructions are configured to cause a processor of a MSMS communication device to perform operations further comprising:
receiving the first subscription using the first receive chain and a second receive path of the second receive chain.

16. The non-transitory processor-readable medium of claim 14, wherein the stored processor-executable instructions are configured to cause a processor of a MSMS communication device to perform operations such that preventing the second subscription from using a first receive path of the second receive chain in response to determining that there is an upcoming overlap between the first subscription schedule and the second subscription schedule comprises:
monitoring a data loss from the broadcast data stream;
determining whether the monitored data loss and an expected data loss exceed a threshold; and
preventing the second subscription from using a first receive path of the second receive chain in response to determining that the monitored data loss and the expected data loss exceeds the threshold.

17. The non-transitory processor-readable medium of claim 16, wherein the stored processor-executable instructions are configured to cause a processor of a MSMS communication device to perform operations further comprising:
enabling the second subscription to use the first receive path of the second receive chain in response to determining that the monitored data loss and the expected data loss does not exceed the threshold.

18. The non-transitory processor-readable medium of claim 16, wherein the stored processor-executable instructions are configured to cause a processor of a MSMS communication device to perform operations such that preventing the second subscription from using a first receive path of the second receive chain in response to determining that the monitored data loss and the expected data loss exceeds the threshold comprises:
determining whether the monitored data loss is less than or equal to the threshold; and
preventing the second subscription from using a first receive path of the second receive chain in response to determining that the monitored data loss and the expected data loss exceeds the threshold and that the monitored data loss is less than or equal to the threshold.

19. The non-transitory processor-readable medium of claim 18, wherein the stored processor-executable instructions are configured to cause a processor of a MSMS communication device to perform operations further comprising:
enabling the second subscription to use the first receive path of the second receive chain in response to determining that the monitored data loss is not less than or equal to the threshold.
